(19) United States
(12) Patent Application Publication
(10) Pub. No.: US 2026/0149646 A1
(43) Pub. Date: May 28, 2026

(54) COMMUNICATION METHOD AND COMMUNICATION APPARATUS

(71) Applicant: Huawei Technologies Co. Ltd., Shenzhen (CN)

(72) Inventors: Yiqun Ge, Ottawa (CA); Hao Tang, Ottawa (CA); Jianglei Ma, Ottawa (CA)

(21) Appl. No.: 19/416,831

(22) Filed: Dec. 11, 2025

Related U.S. Application Data
(63) Continuation of application No. PCT/CN2023/125043, filed on Oct. 17, 2023.
(60) Provisional application No. 63/507,882, filed on Jun. 13, 2023.

(51) Int. Cl. H04L 41/16; G06N 20/00

(52) U.S. Cl. CPC H04L 41/16; G06N 20/00

(57) ABSTRACT

Embodiments of the present application provide a communication method and a communication apparatus. The communication method includes sending first information according to one or more learning metrics, where the one or more learning metrics are based on distance(s) between distribution(s) of outputs of p latent layer(s) in an AI model and distribution of inputs of the AI model during a training cycle, and/or distance(s) between distribution(s) of outputs of p′ latent layer(s) and distribution of outputs of an AI model during a training cycle.

### CROSS-REFERENCE TO RELATED APPLICATIONS

The present application is a continuation of International Application No. PCT/CN2023/125043, filed on Oct. 17, 2023, which claims priority to U.S. Provisional Patent Application No. 63/507,882, filed on Jun. 13, 2023.

The disclosures of the aforementioned applications are hereby incorporated by reference in their entirety.

### TECHNICAL FIELD

Embodiments of the present application relate to the field of communications, and more specifically, to a communication method and a communication apparatus.

### BACKGROUND

Artificial intelligence (AI)-based algorithms have been introduced into wireless communications to solve some wireless problems such as channel estimation, scheduling, channel state information (CSI) compression, positioning, beam-management, and so on. AI algorithm is a data-driven method that tunes some pre-defined architectures by a set of data samples called a training data set.

The training performance of an AI model is crucial for its application. If there are abnormalities in the training process of an AI model, it may affect the convergence speed and/or affect the quality of the trained AI model. For example, the training cycle may be sensitive to bad data. The convergence speed and even learning quality may highly depend on the quality of the training data set. If the training data is bad data, it may cause abnormalities in the training cycle.

Therefore, an urgent technical problem that needs to be solved is how to improve the training performance of the AI model.

### SUMMARY

Embodiments of the present application provide a communication method and a communication apparatus. The technical solutions may improve the training performance of an AI model.

According to a first aspect, an embodiment of the present application provides a communication method, including sending first information according to one or more learning metrics, where the one or more learning metrics are based on distance(s) between distribution(s) of outputs of p latent layer(s) in an AI model and distribution of inputs of the AI model during a training cycle, and/or distance(s) between distribution(s) of outputs of p′ latent layer(s) and distribution of outputs of an AI model during a training cycle, and p and p′ are positive integers.

According to the above technical solution, the one or more learning metrics are related to the mutual information. The one or more learning metrics can be used to check whether the current training is normal according to information bottleneck theory, so that the training process can be adjusted in a timely manner in case of abnormal training, which is beneficial for improving training performance.

The p latent layer(s) of the AI model and the p′ latent layer(s) of the AI model may be the same or different.

The distance above can be calculated by HSIC, JSD, KL and so on.

The one or more learning metrics may be related to n time period(s). n is a positive integer.

In a possible design, the one or more learning metrics are configured to check whether the training cycle is normal.

In a possible design, the one or more learning metrics include at least one learning metric corresponding to a first latent layer among the p latent layer(s) or the p′ latent layer(s) during a first time period among n time period(s) in the training cycle, n is a positive integer, and the at least one learning metric includes at least one of the following: a first learning metric based on a distance between the distribution of the inputs of the AI model and distribution of outputs of the first latent layer during the first time period; a second learning metric based on a distance between the distribution of the outputs of the AI model and the distribution of the outputs of the first latent layer during the first time period; or a third learning metric based on a ratio between the first learning metric and the second learning metric.

In a possible design, the method further includes: receiving second information, and the sending first information according to one or more learning metrics, includes: sending the first information according to the second information.

In a possible design, the method further includes: receiving second information, where the second information is configured to indicate at least one of the following: one or more time periods related to S learning metric(s), one or more latent layers related to the S learning metric(s), one or more methods for measuring the S learning metric(s), or one or more types of the S learning metric(s), where S is a positive integer.

In a possible design, the S learning metric(s) includes the one or more learning metrics.

In a possible design, the first information indicates the one or more learning metrics.

According to a second aspect, an embodiment of the present application provides a communication method, including: receiving first information related to one or more learning metrics, where the one or more learning metrics are based on distance(s) between distribution(s) of outputs of p latent layer(s) in an AI model and distribution of inputs of the AI model during a training cycle, and/or distance(s) between distribution(s) of outputs of p′ latent layer(s) and distribution of outputs of an AI model during a training cycle, and p and p′ are positive integers.

In a possible design, the one or more learning metrics are configured to check whether the training cycle is normal.

In a possible design, the one or more learning metrics include at least one learning metric corresponding to a first latent layer among the p latent layer(s) or the p′ latent layer(s) during a first time period among n time period(s) in the training cycle, and the at least one learning metric includes at least one of the following: a first learning metric based on a distance between the distribution of the inputs of the AI model and distribution of outputs of the first latent layer during the first time period; a second learning metric based on a distance between the distribution of the outputs of the AI model and the distribution of the outputs of the first latent layer during the first time period; or a third learning metric based on a ratio between the first learning metric and the second learning metric.

In a possible design, the method further includes: sending second information, where the second information is configured to indicate at least one of the following: one or more time periods related to S learning metric(s), one or more latent layers related to the S learning metric(s), one or more methods for measuring the S learning metric(s), or one or more types of the S learning metric(s), where S is a positive integer.

In a possible design, the first information indicates the one or more learning metrics.

According to a third aspect, a communication apparatus is provided. The communication apparatus includes a function or unit configured to perform the method according to the first aspect or any one of the possible designs of the first aspect.

For example, the communication apparatus may be a network device or a chip in the network device. For another example, the communication apparatus may be a terminal device or a chip in the terminal device.

According to a fourth aspect, a communication apparatus is provided. The communication apparatus includes a function or unit configured to perform the method according to the second aspect or any one of the possible designs of the second aspect.

For example, the communication apparatus may be a terminal device or a chip in the terminal device. For another example, the communication apparatus may be a network device or a chip in the network device.

According to a fifth aspect, a system is provided. The system includes: the communication apparatus according to the third aspect and the communication apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible designs of the first aspect, or the communication apparatus performs the method in any one of the second aspect or the possible designs of the second aspect.

For example, the communication apparatus may be a network device or a component (for example, a chip or integrated circuit) installed in the network device. For another example, the communication apparatus may be a terminal device or a component (for example, a chip or integrated circuit) installed in the terminal device.

According to a seventh aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform the method according to the first aspect or any one of the possible designs of the first aspect, or the second aspect or any one of the possible designs of the second aspect.

According to an eighth aspect, a computer storage medium is provided. The computer storage medium stores program code, and the program code is used to execute one or more instructions for the method according to the first aspect or any one of the possible designs of the first aspect, or the second aspect or any one of the possible designs of the second aspect.

According to a ninth aspect, the present application provides a computer program product including one or more instructions, where when the computer program product runs on a computer, the computer performs the method according to the first aspect or any one of the possible designs of the first aspect, or the second aspect or any one of the possible designs of the second aspect.

### DESCRIPTION OF DRAWINGS

FIG. 1 is a schematic diagram of an application scenario according to the present application;

FIG. 2 illustrates an example communication system 100;

FIG. 3 illustrates an example device in the communication system;

FIG. 4 is a schematic diagram of a device in two cycles according to an embodiment of the present application;

FIG. 5 illustrates example local data of a device according to an embodiment of the present application;

FIG. 6 is a schematic flowchart of a communication method according to an embodiment of the present application;

FIG. 7 is a schematic diagram of example learning metrics according to an embodiment of the present application;

FIG. 8 is a schematic diagram of example training process of AE according to an embodiment of the present application; and

FIGS. 9-13 are schematic block diagrams of possible devices according to embodiments of the present application.

### DESCRIPTION OF EMBODIMENTS

The following describes technical solutions of the present application with reference to the accompanying drawings.

The embodiments of the present invention may be applied to communication systems of next generation (e.g., sixth generation (6G) or later), 5th Generation (5G), new radio (NR), long term evolution (LTE), or the like.

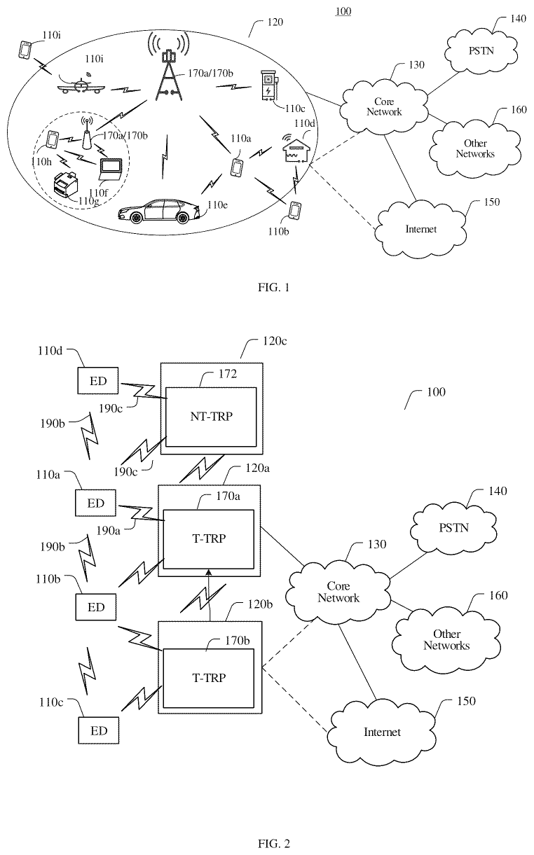

FIG. 1 is a schematic structural diagram of an example communication system.

Referring to FIG. 1, as an illustrative example without limitation, a simplified schematic illustration of a communication system is provided. A communication system 100 includes a radio access network 120. The radio access network 120 may be a next generation (e.g., 6G or later) radio access network, or a legacy (e.g., 5G, 4G, 3G or 2G) radio access network. One or more communication electronic device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

FIG. 2 is a schematic structural diagram of another example communication system.

In general, a communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet protocol (IP), transmission control protocol (TCP), and user datagram protocol (UDP). EDs 110a 110b, and 110c may be multimode devices capable of operation according to multiple radio access technologies, and incorporate multiple transceivers necessary to support such.

The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a personal communications service (PCS) phone, a session initiation protocol phone, a wireless local loop (WLL) station, a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the foregoing devices, among other possibilities. Future generation EDs 110 may be referred to using other terms. The base station 170a and 170b is a T-TRP and will hereafter be referred to as T-TRP 170. A NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay nodes, donor nodes, or the like, or combinations thereof. The T-TRP 170 may refer to the foregoing devices or apparatus (e.g., communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The NT-TRP 172 may be known by other names in some implementations, such as a non-terrestrial node, a non-terrestrial network device, or a non-terrestrial base station.

Artificial intelligence (AI) technologies can be applied in communication, including artificial intelligence or machine learning (AI/ML) based communication in the physical layer and/or AI/ML based communication in the higher layer, such as medium access control (MAC) layer. For example, in the physical layer, the AI/ML based communication may aim to optimize component design and/or improve the algorithm performance. For example, AI/ML may be applied in relation to the implementation of channel coding, channel modelling, channel estimation, channel decoding, modulation, demodulation, multiple-input multiple-output (MIMO), waveform, multiple access, physical layer element parameter optimization and update, beam forming, tracking, sensing, and/or positioning, etc. For the MAC layer, the AI/ML based communication may aim to utilize the AI/ML capability for learning, prediction, and/or making decisions to solve a complicated optimization problem with possible better strategy and/or optimal solution, e.g., to optimize the functionality in the MAC layer. For example, AI/ML may be applied to implement: intelligent transmission and reception point (TRP) management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

In order to facilitate understanding of the embodiments of the present application, terms related to AI/ML that may be involved in the embodiments of the present application are described below.

### (1) Data Collection

Data is a very important component for AI/ML techniques. Data collection is a process of collecting data by the network nodes, management entity, or UE for the purpose of AI/ML model training, data analytics, and inference.

### (2) AI/ML Model Training

AI/ML model training is a process to train an AI/ML Model by learning the input/output relationship in a data driven manner and obtaining the trained AI/ML Model for inference.

### (3) AI/ML Model Inference

A process of using a trained AI/ML model to produce a set of outputs based on a set of inputs.

### (4) AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### (5) AI/ML Model Testing

Similar to validation, testing is also a sub-process of training, and it is used to evaluate the performance of a final AI/ML model using a dataset different from the one used for model training and validation. Different from AI/ML model validation, testing does not assume subsequent tuning of the model.

### (6) Online Training

Online training means an AI/ML training process where the model being used for inference is typically continuously trained in (near) real-time with the arrival of new training samples.

### (7) Offline Training:

Offline training is an AI/ML training process where the model is trained based on the collected dataset, and where the trained model is later used or delivered for inference.

### (8) AI/ML Model Delivery/Transfer

AI/ML model delivery/transfer is a generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### (9) Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for the sustainable operation of AI/ML in the NR air-interface.

Life cycle management covers the whole procedure of AI/ML technologies applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicators (KPIs), and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to environmental changes, and thus the model based on input or output data distribution should also be considered.

### (10) Supervised Learning

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

### (11) Federated Learning (FL)

Federated learning is a machine learning technique that is used to train an AI/ML model by a central node (e.g., server) and a plurality of decentralized edge nodes (e.g., UEs, next Generation NodeBs, “gNBs”). The central node can also be called the central device. The edge nodes can also be called worker or worker devices. The central device is connected to the worker devices.

According to the wireless FL technique, a central node may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the central node, a set of AI/ML model parameters that describe the local AI/ML model.

Upon receiving, from a plurality of edge nodes, a plurality of sets of AI/ML model parameters that describe respective local AI/ML models at the plurality of edge nodes, the central node may aggregate the local AI/ML model parameters reported from the plurality of edge nodes and, based on such aggregation, update the global AI/ML model. A subsequent iteration progresses much like the first iteration. The central node may transmit the aggregated global model to a plurality of edge nodes. The above procedure is performed multiple iterations until the global AI/ML model is considered to be finalized, for example, the AI/ML model is converged or the training stopping conditions are satisfied.

The wireless FL technique does not involve the exchange of local data samples. Indeed, the local data samples remain at respective edge nodes.

AI-based algorithms have been introduced into wireless communications to solve a number of wireless problems such as channel estimation, scheduling, CSI compression (from UE to BS), beamforming for MIMO, localization, and so on. AI algorithms are a data-driven approach to tuning some predefined architectures by a set of data samples called training data sets.

Neural networks are a typical way to implement AI algorithms. Deep neural network (DNN) is taken as an example, the DNN can be trained with the training data sets to obtain a model for inference. Recent AI trains DNN architectures by setting up neurons with stochastic gradient descent (SGD) algorithms. For example, DNN includes CNN, RNN, transformers, and the like.

A communication system includes a plurality of connected devices. For example, a device may be a BS or UE. For example, the communication system may be the communication system 100 in FIG. 1 or FIG. 2, and the devices can be the network elements shown in FIG. 1 or FIG. 2.

FIG. 3 is a schematic structural diagram of a device according to an embodiment of the present application. As shown in FIG. 3, the device may include at least one of sensing module, communication module, or AI module. The sensing module may be configured to sense and collect signals and/or data. The communication module may be configured to transmit and receive signals and/or data. The AI module may be configured to train and/or reason the AI implementations.

In order to facilitate understanding of the embodiment of the present application, DNN is taken as an example to illustrate an AI implementation in an embodiment of the present application.

An exemplary AI implementation is DNN-based in two cycles: a training cycle and an inference cycle. The training cycle may also be called the learning cycle. The inference cycle may also be called the reasoning circle.

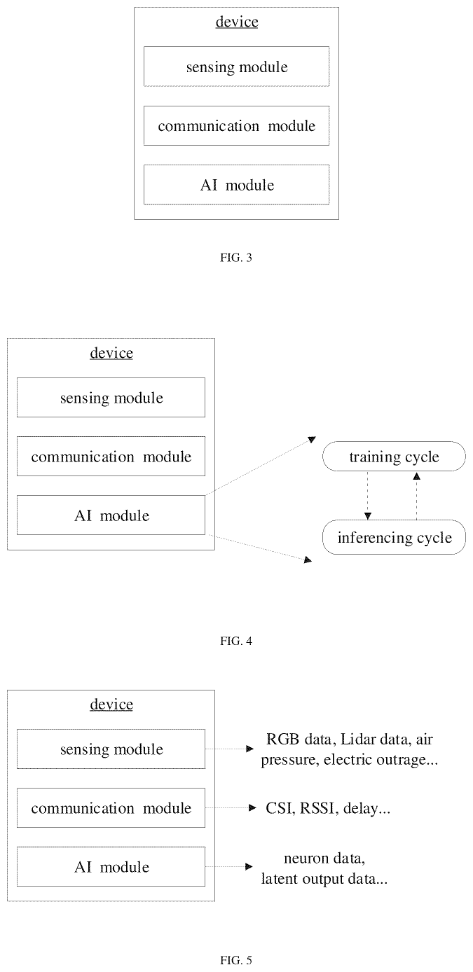

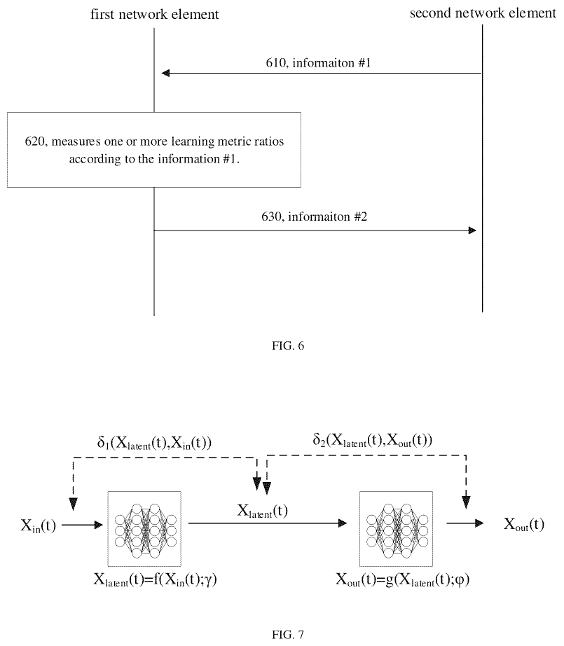

FIG. 4 is a schematic diagram of a device in two cycles according to an embodiment of the present application.

As an example, during an inference cycle, the AI module of the device may perform one inference or a series of inferences with one or more DNNs to fulfill one or more tasks, where the sensing module of the device may generate signals and/or data and the communication module of the device may receive the signals and/or data from other device or devices. For example, the inputs of the one or more DNNs may be the signals and/or data generated by the sensing module of the device, and/or the signals and/or data received by the communication module of the device. After the AI module of the device finishes inferencing, the communication module of the device may transmit the inferencing results to other device or devices.

As another example, during a training cycle, the AI module of the device may train one or more DNNs, where the sensing module of the device may generate signals and/or data and the communication module of the device may receive the signals and/or data from other device or devices. For example, the training data of the one or more DNNs may be the signals and/or data generated by the sensing module of the device, and/or the signals and/or data received by the communication module of the device. During and/or after the AI module finishes training, the communication module of the device may transmit the training results to other device or devices.

The AI implementations may either switch between the two cycles or stay in the two cycles simultaneously.

For example, the AI module of the device may train a DNN during the training cycle. And at the end of the training cycle, the AI implementation switches to the inference cycle, which means the AI module performs inference on that trained DNN. At the end of the inference cycle the AI implementation switches to the training cycle again, and so on.

For another example, the AI module of the device may train a second DNN but still perform inference on a first DNN.

The device mentioned above is merely an example, and the way in which the modules are divided and the number of modules in FIG. 3 and FIG. 4 do not constitute any limitation to the embodiments of the present application. For example, a communication module may be replaced by two modules, i.e., a transmitting module and a receiving module. The transmitting module may be configured to transmit signals and/or data, and the receiving module may be configured to receive signals and/or data. For another example, the sensing module and the communication module may be integrated as one module. For another example, the device may also include a processing module. The processing module may be configured to process signals and/or data. For another example, the device may not include the AI module. For another example, the AI module may only be configured to reason the AI implementation, or the AI module only stays in the inference cycle.

Wireless systems may support AI in both learning and inferencing cycles for generalization and interconnections.

FIG. 5 shows example local data of a device. The local data of a device may include at least one of the following: local sensing data provided by the sensing module of the device, local channel data provided by the communication module of the device, local AI model data provided by the AI module of the device, or local latent output data provided by the AI module of the device. The local channel data is based on the measurement results of the channel. The local channel data can also be considered as sensing results. Thus, the local channel data can be considered as provided by the communication modules or sensing module.

For example, as shown in FIG. 5, the local sensing data may include at least one of RGB data, Lidar data, temperature, air pressure, or electric outage.

For example, as shown in FIG. 5, the local channel data may include at least one of channel state information (CSI), received signal strength indication (RSSI), or delay.

The local AI model data can also be referred to as neuron data. For example, as shown in FIG. 5, the local AI model data may include at least one of the following: part or all of the neurons in the local AI model(s) deployed on the device or part or all of gradients of the local AI model(s) deployed on the device. Neurons can be considered as functions including weights.

For example, as shown in FIG. 5, the local latent output data may include one or more latent outputs of the local AI model(s) deployed on the device.

A device may receive the local data of one or more other devices. As an example, the data received by the communication module of the device may include at least one of sensing data of one or more other devices, channel data of one or more other devices, AI model data of one or more other devices, or latent output data of one or more other devices.

For example, the data received by the communication module of device #A may include channel data of device #B and device #C, and AI model data of device #C. The channel data of device #B and device #C refer to the local channel data of device #B and the local channel data of device #C. The AI model data of device #C refers to the local AI model data of device #C. Device #A, device #B, and device #C are different devices.

For example, sensing data received by the communication module may include at least one of RGB data, Lidar data, temperature, air pressure, or electric outage.

For example, channel data received by the communication module may include at least one of CSI, RSSI, or delay.

For example, AI model data received by the communication module may include at least one of part or all of the neurons in the AI model(s), or part or all of gradients of the AI model(s).

For example, latent output data received by the communication module may include one or more latent outputs of the AI model(s).

During the training cycle, the AI module of a device may work in a single user mode or cooperative mode.

In the single user mode, the AI module of a device may train the one or more local AI models with the local data of the device.

In the cooperative mode, the AI module of a device may train the one or more local AI models with the data received from the communication module of the device.

For example, the data received from the communication module of the device may be used by the AI module to train the local AI model(s) in the following ways.

Alternative #1: the sensing data received by the communication module of the device may be accumulated into one training data set for training the local AI model(s).

Alternative #2: the channel data received by the communication module of the device may be accumulated into one training data set for training the local AI model(s).

Alternative #3: part or all of the neurons in the local AI model(s) may be set based on the AI model data received by the communication module of the device. For example, in a federated learning mode, neurons of an AI model on one device may be set based on the neurons or gradients of the AI model(s) on other device(s). Or, the gradients that the communication module of the device received may be used to update the neurons in the local AI model(s).

Alternative #4: the latent outputs received by the communication module of the device may be inputted to its local AI model(s). For example, when device #A and device #B work together to train a DNN, the device #A trains the first part of the DNN and the device #B trains the second part of the DNN. The device #A's communication module transmits the latent output of the first part of the DNN to the device #B. The device #B receives the latent output of the first part and inputs the latent output to the second part of the DNN.

In addition, the local data of a device and the data received by the communication module of the device can be used together to train the local AI model(s).

For example, the local data of a device and the data received by the communication module of the device can be used by the AI module to train the local AI model(s) in the following ways.

Alternative #1: the local sensing data provided by the sensing module of the device and the sensing data received by the communication module of the device may be mixed into one training data set for training the local AI model(s).

Alternative #2: the local channel data provided by the sensing module of the device and the channel data received by the communication module of the device may be mixed into one training data set for training the local AI model(s).

Alternative #3: part or all of the neurons in the local AI model(s) possessed by the AI module of the device and the corresponding neurons received by the communication module of the device may be averaged as the neurons in the updated local AI model(s). Or, part or all of the gradients of the local AI model(s) possessed by the AI module of the device and the corresponding gradients received by the communication module of the device may be used to update the neurons in the local AI model(s).

Alternative #4: the local latent outputs possessed by the AI module of the device and the latent outputs received by the communication module of the device may be averaged and inputted to its DNN(s).

The training performance of an AI model is crucial for its application. If there are abnormalities in the training process of an AI model, it may affect the convergence speed and/or the quality of the trained AI model. For example, the training cycle may be sensitive to bad data. The convergence speed and even learning quality may highly depend on the quality of the training data set. If the training data is bad data, it may cause abnormalities in the training cycle.

The embodiment of the present application provides a communication method that detects the training process of an AI model by detecting the difference between at least two items in the latent layer, input layer, and output layer, thereby improving the training performance.

FIG. 6 is a schematic flowchart of a communication method provided by the embodiments of the present application.

As shown in FIG. 6, method 600 includes the following steps.

Step 610, a first network element receives information #1 from a second network element.

Step 620, the first network element measures one or more learning metrics of an AI model according to the information #1.

The one or more learning metrics may be related to P latent layer(s) of the AI model. The P latent layer(s) may include p latent layer(s) of the AI model and/or p′ latent layer(s) of the AI model. P is a positive integer.

The one or more learning metrics are based on at least one of the following: the difference(s) between distribution(s) of the outputs of the p latent layer(s) and the distribution of the inputs of the AI model, or the difference(s) between the distribution(s) of the outputs of the p′ latent layer(s) and the distribution of the outputs of the AI model. p and p′ are positive integers.

The p latent layer(s) of the AI model and the p′ latent layer(s) of the AI model may be the same or different.

The difference between the two in the embodiment of the present application can also be understood as the distance between the two. For example, the difference(s) between distribution(s) of the outputs of the p latent layer(s) and the distribution of the inputs of the AI model can also be referred to as the distance(s) between the distribution(s) of the outputs of the p latent layer(s) and the distribution of the inputs of the AI model.

The one or more learning metrics may be related to n time period(s). n is a positive integer.

For example, the first network element may be the device in FIG. 3. The communication module of the first network element may receive the information #1. The AI module of the first network element may perform the step 620.

For example, the first network element may be a terminal device or a network device.

For example, the second network element may be the device in FIG. 3. The communication module of the second network element may transmit the information #1.

For example, the second network element may be a network device or a terminal device.

The AI model may be an AI model under training. The AI model can be a neural network model, such as a deep neural network (DNN) model.

A learning metric is related to a time period and/or a latent layer.

For example, the learning metric may be in function of time period and/or latent layer.

A time period can be represented in multiple ways.

Exemplarily, a time period may be represented by one or more epochs. For example, an epoch can serve as a time period.

Exemplarily, a time period may be represented by one or more batches. For example, a batch can serve as a time period.

Exemplarily, a time period may be represented by at least two items: starting time, ending time, or the duration.

The time period can also be represented in other ways, and the embodiments of the present application do not limit this.

During the training cycle, the AI module of a device may work in a single user mode or cooperative mode. In both modes, the device may calculate the one or more learning metrics over one or more time periods, such as epoch by epoch, or batch by batch.

The AI model may include M latent layer(s). M is a positive integer. M≥P. The P latent layer(s) belongs to the M latent layer(s). The M latent layer(s) may be denoted as T(t)=[T₁(t), T₂(t), . . . , T_{M}(t)]. T(t) represents the output(s) of the M latent layer(s) corresponding to the time period t. T₁(t) represents the output of the first latent layer among the M latent layer(s) corresponding to the time period t, T₂(t) represents the output of the second latent layer among the M latent layer(s) corresponding to the time period t, and so on. The elements in T(t) can also be arranged in other order. The embodiments of the present application do not limit this. For the convenience of description, T(t) mentioned above is taken as an example in the embodiments of the present application.

For example, a time period may be an epoch, in which case, time period t may be the t-th epoch. T(t) may represent the output(s) of the M latent layer(s) at the t-th epoch, T₁(t) may represent the output of the first latent layer among the M latent layer(s) at the t-th epoch, T₂(t) may represent the output of the second latent layer among the M latent layer(s) at the t-th epoch, and so on.

For another example, a time period may be a batch, in which case, time period t may be the t-th batch. T(t) may represent the output(s) of the M latent layer(s) corresponding to the t-th batch, T₁(t) may the output of the first latent layer among the M latent layer(s) corresponding to the t-th batch, T₂(t) may represent the output of the second latent layer among the M latent layer(s) corresponding to the t-th batch, and so on.

According to information bottleneck theory, during the same time period, the mutual information between the distribution of the inputs to the AI model and the distribution of the latent layer's outputs decreases over the layers, and the mutual information between the distribution of the outputs from the AI model and the distribution of the latent layer's outputs increases over the layers. In other words, the closer the latent layer is to the input layer of the AI model, the greater the mutual information between the distribution of its outputs and the distribution of the inputs to the AI model, and the closer the latent layer is to the output layer of the AI model, the greater the mutual information between the distribution of its outputs and the distribution of the outputs from the AI model.

In addition, the mutual information between the distribution of the inputs to the AI model and the distribution of the latent layer's outputs decreases over the time periods, and the mutual information between the distribution of the outputs from the AI model and the distribution of the latent layer's outputs increases over the time periods.

The one or more learning metric(s) can be related to the mutual information.

For one time period, a latent layer in the P latent layer(s) corresponds to at least one learning metric.

Optionally, the one or more learning metrics include at least one learning metric corresponding to a first latent layer among the p latent layer(s) or the p′ latent layer(s) during a first time period among n time period(s) in the training cycle, n is a positive integer, and the at least one learning metric includes at least one of a first learning metric corresponding to the first latent layer, a second learning metric corresponding to the first latent layer or a third learning metric corresponding to the first latent layer.

The first latent layer may belong to the p latent layer(s). The first learning metric is based on a distance between the distribution of the inputs of the AI model and distribution of outputs of the first latent layer during the first time period.

The first latent layer may belong to the p′ latent layer(s). The second learning metric is based on a distance between the distribution of the outputs of the AI model and the distribution of the outputs of the first latent layer during the first time period.

The first latent layer may belong to the p latent layer and the p′ latent layer(s). The third learning metric is based on a ratio between the first learning metric and the second learning metric.

The “first latent layer” in the “at least one learning metric corresponding to a first latent layer” is only used to describe the at least one metric corresponding to one latent layer, and does not limit the position or order of this latent layer among M latent layer(s). The “first latent layer” can be any of the latent layer(s). For example, the “first latent layer” mentioned above can be the m-th latent layer. 1≤m≤M. m is an integer.

Optionally, the at least one learning metric on one latent layer (e.g., the m-th latent layer) corresponding to one time period (e.g., time period t) may include at least one of the following.

(1) learning metric #1 (an example of the first learning metric) corresponding to one latent layer during one time period may be the distance between the distribution of the inputs to the AI model and the distribution of the latent layer's outputs during the time period.

The m-th latent layer is taken as an example, the learning metric #1 corresponding to the m-th latent layer during the time period t may be the distance between distribution of the inputs to the AI model X(t) and the distribution of the m-th latent layer's outputs Tₘ(t) during the time period t. 1≤m≤M. m is an integer. The learning metric #1 corresponding to the m-th latent layer during the time period t can be denoted as δ₁(Tₘ(t), X(t)).

(2) learning metric #2 (an example of the second learning metric) corresponding to one latent layer during one time period may be the distance between the distribution of the latent layer's outputs and the distribution of the outputs from the AI model during the time period.

The m-th latent layer is taken as an example, the learning metric #2 corresponding to the m-th latent layer during the time period t may be the distance between the distribution of the m-th latent layer's outputs and the distribution of the outputs from the AI model Y(t) during the time period t. The learning metric #2 corresponding to the m-th latent layer during the time period t can be denoted as δ₂(Tₘ(t), Y(t)).

(3) learning metric #3 (an example of the third learning metric) corresponding to one latent layer during one time period may be the ratio between learning metric #1 corresponding to the latent layer during the time period and learning metric #2 corresponding to the latent layer during the time period.

The learning metric #3 may also be called learning metric ratio.

The m-th latent layer is taken as an example. For example, the learning metric #3 corresponding to the m-th latent layer during the time period t may be denoted as

$${ρ}_{m} ( t ) = \frac{{δ}_{1} ( {T}_{m} ( t ) , X ( t ) )}{{δ}_{2} ( {T}_{m} ( t ) , Y ( t ) )} .$$

For another example, the learning metric #3 corresponding to the m-th latent layer during the time period t may be denoted as

$${ρ}_{m}^{′} ( t ) = \frac{{δ}_{2} ( {T}_{m} ( t ) , Y ( t ) )}{{δ}_{1} ( {T}_{m} ( t ) , X ( t ) )} .$$

For the convenience of description,

$${ρ}_{m} ( t ) = \frac{{δ}_{1} ( {T}_{m} ( t ) , X ( t ) )}{{δ}_{2} ( {T}_{m} ( t ) , Y ( t ) )}$$

is taken as an example in the embodiments of the present application for explanation.

FIG. 7 shows a schematic diagram of example learning metrics.

As shown in FIG. 7, for example, the AI model may be an autoencoder (AE), and Tₘ(t) may be the output of the encoder in the AE, that is, the input of the decoder in the AE. The AE may satisfy the following formula:

$${X}_{l a t e n t} ( t ) = f ( {X}_{i n} ( t ) , γ ) ; \\ {x}_{o u t} ( t ) = g ( {X}_{l a tent} ( t ) , φ ) ;$$

f( ) represents the encoder of the AE, and γ represents the parameters of the encoder f( ). g( ) represents the decoder of the AE, and φ0 represents the parameters of the decoder g( ). Xᵢₙ(t) represents the inputs to the AE and the Xₒᵤₜ(t) represents the outputs from the AE. The learning metric #1 corresponding to the latent layer during the time period t can be denoted as δ₁(Xₗₐₜₑₙₜ(t), Xᵢₙ(t)). The learning metric #2 corresponding to the latent layer during the time period t can be denoted as δ₂(Xₗₐₜₑₙₜ(t), Xₒᵤₜ(t)). The learning metric #3 corresponding to the latent layer during the time period t can be denoted as

$${ρ}_{m} ( t ) = \frac{{δ}_{1} ( {X}_{l a t ent} ( t ) , {X}_{in} ( t ) )}{{δ}_{2} ( {X}_{l a t ent} ( t ) , {X}_{out} ( t ) )} .$$

The distance involved in the learning metric mentioned above can be calculated with methods that can be used to approximate mutual information.

For example, mutual information can be approximated by HSIC, JSD, KL, and so on. Correspondingly, the distance above can be calculated by HSIC, JSD, KL, and so on.

In this way, the one or more learning metrics can be used to determine whether a training cycle is normal.

For a normal training cycle, during a time period t, the learning metric #1 decreases over the layers: δ₁(Tₘ₊₁(t), X(t))≤δ₁(Tₘ(t), X(t)). δ₁(Tₘ₊₁(t), X(t)) represents learning metric #1 corresponding to the (m+1)-th latent layer during the time period t.

For a normal training cycle, during a time period t, the learning metric #2 increases over the layers: δ₂(Tₘ₊₁(t), Y(t))≥δ₂(Tₘ(t), Y(t)). δ₂(Tₘ₊₁(t), Y(t)) represents learning metric #2 corresponding to the (m+1)-th latent layer during the time period t.

For a normal training cycle, the learning metric #1 decreases over the time periods: δ₁(Tₘ(t+1), X(t+1))≤δ₁(Tₘ(t), X(t)). δ₁(Tₘ(t+1), X(t+1)) represents learning metric #1 corresponding to the m-th latent layer during the time period (t+1).

For a normal training cycle, the learning metric #2 increases over the time periods: δ₂(Tₘ(t+1), Y(t+1))≥δ₂(Tₘ(t), Y(t)). δ₂(Tₘ(t+1), Y(t+1)) represents learning metric #2 corresponding to the m-th latent layer during the time period (t+1).

Therefore, if the learning cycle is normal, during a time period t, the learning metric #3 may decrease over the layers, such as ρ₁(t)<ρ₂(t)< . . . <ρ_{M}(t). ρ₁(t) represents the learning metric #3 corresponding to the first latent layer during the time period t, ρ₂(t) represents the learning metric #3 corresponding to the second latent layer during the time period t, and so on.

If the learning cycle is normal, for the m-th latent layer, the learning metric #3 may decrease over the timing periods, such as: ρₘ(t)<ρₘ(t+1)< . . . <ρₘ(t+Δt). Δt>0. ρₘ(t) represents the learning metric #3 corresponding to the m-th latent layer during the time period t, ρₘ(t+1) represents the learning metric #3 corresponding to the m-th latent layer during the time period (t+1), and so on.

The one or more learning metrics can be obtained through one or more measurements.

The conditions for determining whether a training cycle is normal can be set according to the above trends.

If the one or more learning metrics don't match one or more of the above trends, it is possible that the training cycle is abnormal.

For example, as long as the one or more learning metrics do not meet one of the trends mentioned above, the training cycle can be considered abnormal.

For another example, if the one or more learning metrics do not meet all the above trends, the training cycle can be considered abnormal.

Basically, if a method for approximating mutual information doesn't change the tendencies above, it can be used as the method for computing the distance involved in the learning metric(s).

In the embodiments of the present application, the one or more learning metrics can be used to check whether the current training is normal, so that the training process can be adjusted in a timely manner in case of abnormal training, which is beneficial for improving training performance.

The one or more metrics of the first AI model can be used to perform checking. For example, as mentioned above, the one or more learning metrics may be used to check whether the current training is normal. In addition, the above checking can be replaced with other descriptions. For example, performing checking may include checking whether the AI model can be trained as expected, checking whether the one or more learning metrics meet the expectation; checking whether the one or more learning metrics meet the conditions, or checking whether the AI model meets expectations. For ease of description, the embodiments of the present application mainly take “the one or more learning metrics are used to check whether the training cycle is normal” as an example, and do not constitute a limitation on the technical solutions of the embodiments of the present application.

The second network element may send information #1 in broadcast, multicast, or unicast way.

In some embodiments, the information #1 may be used to trigger the measurement.

The first network element receives the information #1, and then measures the one or more learning metrics.

For example, the information #1 may be used to indicate the first network element to measure the one or more metrics.

For another example, the information #1 may be used to indicate the first network element to send the one or more metrics.

For another example, the information #1 may be used to indicate the first network element to check whether the training cycle is normal.

The information #1 may indicate checking whether the training cycle is normal with the one or more metrics. Alternatively, it may be predefined to use the one or more metrics to check whether the training cycle is normal. Alternatively, the first network element may decide to use the one or more metrics to check whether the training cycle is normal.

The first network element receives the information #1. Then the first network element measures the one or more learning metrics, and check whether the training cycle is normal according to the one or more learning metrics.

For another example, the information #1 may be used to indicate the first network element to send the check result of the training cycle.

In some embodiments, the information #1 (an example of the second information) may be used to indicate at least one of the following: one or more time periods related to S learning metric(s), one or more latent layers related to the S learning metric(s), the one or more methods for measuring the S learning metric(s), one or more types of the S learning metric(s). S is a positive integer.

The method for measuring a learning metric may include the method for calculating the distance mentioned above, such as HSIC, JSD, KL, and so on.

The type of the leaning metric may include the leaning metric #1, leaning metric #2, and/or the leaning metric #3.

Exemplarily, the first network element may receive a message that asks for measuring S learning metric(s), which specifies on which layer(s) in which time period(s) to measure which learning metric(s) in which method(s).

For example, the message may ask for measuring learning metric #3 corresponding to m-th latent layer at t-th epoch, where the distance involved in measuring the learning metric #3 is calculated using KL.

The above items that are not indicated by information #1 can be indicated by other information sent by the second network element, pre-configured, determined by the first network element itself, or predefined. Alternatively, all of the above items can be determined by the first network element itself, and/or predefined.

Exemplarily, the AI module of the first network element may follow the information #1 to perform the measurement and computations on its AI model undertrained.

In this case, the one or more learning metrics measured by the first network element are the S metrics indicated by the information #1.

In addition, the first network element can also perform measurement without following the items requested by the information #1. In other words, the one or more learning metrics measured by the first network element in step 620 may be differ from the S learning metric(s) indicated by the information #1.

For example, the information #1 may ask for measuring learning metric(s) #3 corresponding to P′ latent layer(s) at t-th epoch, where the distance(s) involved in measuring the learning metric(s) #3 is calculated using KL. The first network element may measure learning metric(s) #3 corresponding to P latent layer(s) at t-th epoch, where the distance(s) involved in measuring the learning metric(s) #3 is calculated using KL. P′ is a positive integer. The P latent layer(s) may be some of the P′ latent layer(s).

The step 610 can be an optional step. For example, the first network element itself may determine to perform step 620.

Further, optionally, the first network element may store the one or more learning metrics measured by the first network element in step 620.

For example, the first network element may store the one or more learning metrics in function of time periods and the latent layers.

Further, optionally, the method 600 may also include: checking whether the training cycle of the AI model is normal with the one or more learning metrics measured by the first network element in step 620.

The AI module of the first network element may do the statistics on the accumulated learning metrics to check if the learning metrics satisfy the decreasing or increasing properties above. If the AI module of the first network element suspects an abnormal decrease or increase of the learning metrics, it may decide that the training cycle is abnormal. The AI module of the first network element may raise an alarming message.

For example, the first network element may measure learning metrics #3 corresponding to a plurality of latent layers at t-th epoch. If the learning metrics #3 don't satisfy ρ₁(t)<ρ₂(t)< . . . <ρ_{M}(t), the first network may decide that the training cycle is abnormal.

For example, the first network element may measure learning metrics #3 corresponding to m-th of latent layer at a plurality of epochs. If the learning metrics #3 don't satisfy ρₘ(t)<ρm(t+1)< . . . <ρₘ(t+Δt), the first network may decide that the training cycle is abnormal.

The above conditions are only an example. The conditions for determining whether inference cycle is normal can be set as needed.

Further, optionally, the method 600 may also include step 630.

Step 630, the first network element sends information #2 (an example of the first information) to the second network element according to the one or more learning metrics.

Optionally, the information #2 may be used to indicate the one or more learning metrics.

For example, the communication module of the first network element may send the information #2.

In some embodiments, the information #2 may include the one or more learning metrics measured by the first network element.

Optionally, the first network element may report the one or more learning metrics when the measurement is completed.

Alternatively, the first network element may report the one or more learning metrics if the training cycle is abnormal.

In some cases, the second network element may not be aware of the items related to the one or more learning metrics, such as the latent layer(s) corresponding to the one or more learning metrics.

For example, the first network element may not follow the items indicated by the information #1 to perform the measurements. Or, the information #1 may be used to trigger the first network element to perform the measurements.

In the above cases, the first network element may send information indicating the items related to the one or more learning metrics.

For example, the first network element may send information indicating on which layer(s), in which time period(s), and in which method(s) which learning metric(s) is measured. The information #2 may include some or all of the one or more learning metrics.

For example, the first network element may report the learning metrics that the AI module judges as abnormal.

The second network element can also determine whether the training cycle of the AI model is normal with the one or more learning metrics.

In some embodiments, the information #2 may indicate other content related to the one or more learning metrics.

For another example, there may be multiple ranges. Each range corresponds to a level. The information #2 may indicate the level(s) corresponding to the range(s) to which the one or more learning metrics belong.

For another example, the information #2 may indicate whether the training cycle of the AI model is normal.

The following describes an exemplary explanation of method 600 of the embodiments in the present application based on two examples (Example scenario-1 and Example scenario-2).

### Example Scenario-1

Optionally, method 600 may be applied in federated learning.

There is a communication system including one central device and a plurality of worker devices. For example, the worker device may include the modules shown in FIG. 3, where the sensing module may be used to collect the local data, AI module may be used to train its local AI model such as a DNN, and communication module may be used to receive signals and/or data from the central device and transmit signals and/or data to the central device. The central device may at least include a communication module and an AI module shown in FIG. 3.

For example, the central device can be the second network element in method 600, and the worker device can be first network element in method 600.

The following describes an example of a possible implementation of federated learning.

The central device and the worker devices may work together epoch by epoch in a federated learning way. Specifically, the communication module of a worker device transmits all of the its local neurons or a portion of its local neurons to the central device. The communication module of the central device receives these neurons from a plurality of the worker devices, the AI module of the central device aggregates these neurons and updates the AI model based on this, and then the communication module transmits the updated neurons to in a broadcast or multicast way to the worker devices. For example, the AI module of the central device averages these neurons, and then the communication module of the central device transmits the averaged neurons to the worker devices. The communication module of a worker device receives the updated neurons and the AI module of the worker device sets the updated neurons into its local DNN. Then the AI module of the worker device trains the updated local DNN. Repeat the above process epoch by epoch, or batch by batch, until the central device and the worker devices finish training the DNN. The DNN trained on all the involved worker devices in the federated learning must have the identical architecture.

On top of the traditional federated learning above, the following illustrates an example of the application of the technical solution of the present application to federated learning.

The communication module of the central device may send information #1 in broadcast, multicast, or unicast way.

The information #1 may be used to indicate one or more of the following: one or more time periods related to one or more learning metrics, one or more latent layers related to the one or more learning metrics, the one or more methods for measuring the one or more learning metrics, one or more types of the one or more learning metrics.

For example, the communication module of the central device may send the messages to the worker devices in broadcast, multicast, or unicast way to inform the worker devices of on which layer(s) in which time period(s) to measure which learning metric(s) in which method(s).

The above process corresponds to step 610, and the specific description can refer to step 610, which will not be repeated here.

The communication module of a worker device may receive the information #1 so that the AI module of the worker device may perform the measurements on its AI model undertrained according to the information #1.

Further, the AI model of the worker device may memorize the one or more learning metrics.

For example, the AI model of the worker device may memorize the learning metrics in function of the latent layers and time periods.

Further, the AI model of the worker device may check whether the training cycle of the AI model is normal with the one or more learning metrics.

The above process corresponds to step 620, and the specific description can refer to step 620, which will not be repeated here.

Further, the communication module of the worker device may transmit the one or more learning metrics to the central device.

Alternatively, the communication module of the worker device may transmit the learning metric(s) that the AI module of the worker device judges as abnormal to the central device.

The above process corresponds to step 630, and the specific description can refer to step 630, which will not be repeated here.

The above is only an example process of the application of the technical solutions in the present application embodiments to federated learning. The technical solutions in the present application embodiments can also be implemented in other ways when it is applied to federated learning, and the related description can refer to method 600, which will not be repeated here.

The one or more learning metrics may reflect the training status of the AI models on the working devices.

Thus, the one or more learning metrics may be used to update the parameters of the AI model in the central device.

For example, the one or more learning metrics may be related to the weight of neurons sent by the corresponding worker device in the aggregation. If the one or more learning metrics sent by a worker device are abnormal, the central device may update the AI model without the neurons sent by the worker device. In this way, it can be avoided that the neurons of an AI model with abnormal training cycle affect the update of the AI model on the central device, which is conducive to ensuring the training quality of the AI model on the central device.

### Example Scenario-2

In some scenarios, a plurality of AI models deployed on different devices may need to work together. These AI models may be trained independently by different providers.

For example, an encoder and a decoder deployed on different devices may need to work together.

Optionally, method 600 may be applied to train autoencoders on different devices. After the training is completed, the encoder can be deployed on the transmitter side and the decoder can be deployed on the receiver side. The transmitter side is an encoding device. The receiver side is a decoding device. The encoder of the encoding device may output to the decoder of the decoding device.

The following takes a DNN-based autoencoder as an example. The encoder can be an encoding DNN and the decoder can be a decoding DNN.

There are two devices, device #1 and device #2 used to train AEs respectively. For example, the device #1 may include the modules shown in FIG. 3, where the sensing module may be used to collect the local data, AI module may be used to train a DNN-based autoencoder #1 with its local data, and communication module may be used to receive signals and/or data and transmit signals and/or data. The device #2 may include the modules shown in FIG. 3, where the sensing module may be used to collect the local data, AI module may be used to train a DNN-based autoencoder #2 with its local data, and communication module may be used to receive signals and/or data and transmit signals and/or data.

The device #1 can be the first network element.

The AI module of the device #1 may measure the one or more learning metrics.

Further, the AI module of the device #1 may memorize the one or more learning metrics.

The above process corresponds to step 620, and the specific description can refer to step 620, which will not be repeated here.

In some implementations, the device #2 may send the information #1 to the device #1. The device #1 may measure the one or more learning metrics according to the information #1. In this case, the device #2 can be considered as the second network element.

For example, the device #2 may send the information #1 to the device #1 to ask the device #1 to perform the measurement and feedback the learning metrics.

The above process corresponds to step 610, and the specific description can refer to step 610, which will not be repeated here.

FIG. 8 shows a schematic diagram of example training process of AE.

The AI module of the device #1 trains the autoencoder #1 with its local data. f₁( ) represents the encoder of the autoencoder #1. γ₁ represents parameters of the encoder f₁( ) g₁( ) represents the decoder of the autoencoder #1, and φ₁ represents parameters of the decoder g₁( ) The output of the encoder is the input of the decoder.

Xᵢₙ₁(t) represents the inputs to the AE #1 and the Xₒᵤₜ₁(t) represents the outputs from the AE #1. The learning metric #1 corresponding to a latent layer during the time period t can be denoted as δ₁(Xₗₐₜₑₙₜ₁(t), Xᵢₙ₁(t)). Xₗₐₜₑₙₜ₁(t) represents the outputs of the latent layer of the autoencoder #1 during the time period t. The learning metric #2 corresponding to the latent layer during the time period t can be denoted as δ₂(Xₗₐₜₑₙₜ₁(t), Xₒᵤₜ₁(t)). The learning metric #3 corresponding to the latent layer during the time period t can be denoted as

$${ρ}_{m} ( t ) = \frac{{δ}_{1} ( {X}_{latent 1} ( t ) , {X}_{in 1} ( t ) )}{{δ}_{2} ( {X}_{latent 1} ( t ) , {X}_{out 1} ( t ) )} .$$

The AI module of the device #1 measures the one or more learning metrics, such as

$${ρ}_{m} ( t ) = \frac{{δ}_{1} ( {X}_{latent 1} ( t ) , {X}_{in 1} ( t ) )}{{δ}_{2} ( {X}_{latent 1} ( t ) , {X}_{out 1} ( t ) )} .$$

The AI module of the device #1 may check whether the training cycle is normal with the one or more learning metrics.

The AI module of the device #2 trains the autoencoder #2 with its local data. f₂( ) represents the encoder of the autoencoder #2. γ₂ represents parameters of the encoder f₂( ) g₂( ) represents the decoder of the autoencoder #2, and φ₂ represents parameters of the decoder g₂( ) The output of the encoder is the input of the decoder.

Xᵢₙ₂(t) represents the inputs to the AE #2 and the Xₒᵤₜ₂(t) represents the outputs from the AE #2. The learning metric #1 corresponding to a latent layer during the time period t can be denoted as δ₁(Xₗₐₜₑₙₜ₂(t), Xᵢₙ₂(t)). Xₗₐₜₑₙₜ₂(t) represents the outputs of the latent layer of the autoencoder #2 during the time period t. The learning metric #2 corresponding to the latent layer during the time period t can be denoted as δ₂(Xₗₐₜₑₙₜ₂(t), Xₒᵤₜ₂(t)). The learning metric #3 corresponding to the latent layer during the time period t can be denoted as

$${ρ}_{m} ( t ) = \frac{{δ}_{1} ( {X}_{latent 2} ( t ) , {X}_{in 2} ( t ) )}{{δ}_{2} ( {X}_{latent 2} ( t ) , {X}_{out 2} ( t ) )} .$$

Further, the AI module of the device #2 may measure the one or more learning metrics, such as

$${ρ}_{m} ( t ) = \frac{{δ}_{1} ( {X}_{latent 2} ( t ) , {X}_{in 2} ( t ) )}{{δ}_{2} ( {X}_{latent 2} ( t ) , {X}_{out 2} ( t ) )} .$$

The AI module of the device #2 may check whether the training cycle is normal with the one or more learning metrics.

Further, the communication module of the device #1 may transmit the one or more learning metrics to the device #2.

Alternatively, the communication module of the device #1 may transmit the learning metric(s) that the AI module of the device #1 judges as abnormal to the device #2.

The above process corresponds to step 630, and the specific description can refer to step 630, which will not be repeated here.

For example, the encoding DNN of the autoencoder #1 trained by the device #1 can be deployed on the encoding device, and the decoding DNN of the autoencoder #2 trained by the device #2 can be deployed on the decoding device.

Alternatively, the decoding DNN of the autoencoder #1 trained by the device #1 can be deployed on the decoding device, and the encoding DNN of the autoencoder #2 trained by the device #2 can be deployed on the encoding device.

The above is only an example process of the application of the technical solutions in the present application embodiments to AE training. The technical solutions in the present application embodiments can also be implemented in other ways when it is applied to AE training, and the related description can refer to method 600, which will not be repeated here.

The transmission process in example scenario-1 and example scenario-2 are merely examples. For other implementation methods, please refer to method 600.

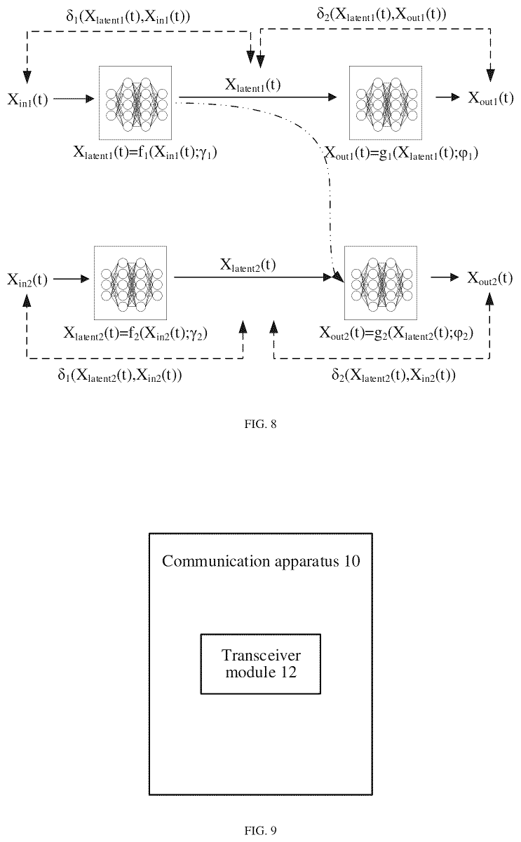

The communication method according to the embodiments of the present application is described in detail above, and the communication apparatus according to the embodiments of the present application will be described in detail below with reference to FIGS. 9-13.

FIG. 9 is a schematic block diagram of a communication apparatus 10 according to an embodiment of the present application. As shown in FIG. 9, the communication apparatus 10 includes:

a transceiver module 12, configured to send first information according to one or more learning metrics, where the one or more learning metrics are based on distance(s) between distribution(s) of outputs of p latent layer(s) in an AI model and distribution of inputs of the AI model during a training cycle, and/or distance(s) between the distribution(s) of the outputs of the p′ latent layer(s) and distribution of outputs of the AI model during the training cycle, and p and p′ are positive integers.

The communication apparatus 10 in this embodiment of the present application may correspond to the first network element in the communication method in the embodiments of the present application described above, and the foregoing management operations and/or functions and other management operations and/or functions of modules of the communication apparatus 10 are intended to implement corresponding steps of the foregoing methods. For brevity, details are not described herein again.

The transceiver module 12 in this embodiment of the present application may be implemented by a transceiver.

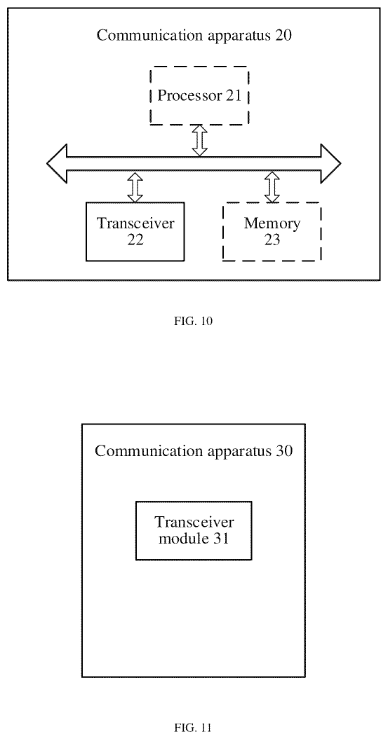

As shown in FIG. 10, a communication apparatus 20 may include a transceiver 21. Optionally, the communication apparatus 20 may further include a processor 22 and/or a memory 23. The memory 23 may be configured to store indication information, or may be configured to store code, instructions, and the like that is to be executed by the processor 22.

FIG. 11 is a schematic block diagram of a communication apparatus 30 according to an embodiment of the present application. As shown in FIG. 11, the communication apparatus 30 includes:
a transceiver module 31, configured to receive first information related to one or more learning metrics, where the one or more learning metrics are based on distance(s) between distribution(s) of outputs of p latent layer(s) in an AI model and distribution of inputs of the AI model during a training cycle, and/or distance(s) between the distribution(s) of the outputs of the p′ latent layer(s) and distribution of outputs of the AI model during the training cycle, and p and p′ are positive integers.

The communication apparatus 30 in this embodiment of the present application may correspond to the second network element in the communication method in the embodiments of the present application described above, and the management operations and/or functions and other management operations and/or functions of modules of the communication apparatus 30 are intended to implement corresponding steps of the foregoing methods. For brevity, details are not described herein again.

The transceiver module 31 in this embodiment of the present application may be implemented by a transceiver.

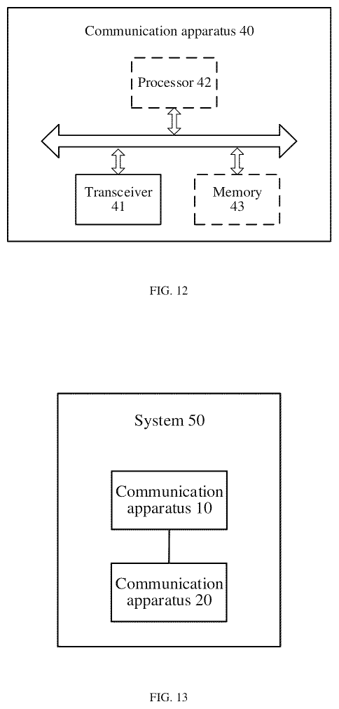

As shown in FIG. 12, a communication apparatus 40 may include a transceiver 41. Optionally, the communication apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processing module 21 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, a discrete gate or a transistor logic device, or a discrete hardware component. All methods, steps, and logical block diagrams disclosed in this embodiment of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random-access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

It may be understood that the memory 23 or the memory 43 in the embodiments of the present invention may be a volatile memory or a non-volatile memory, or may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and be used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The storage of the system and the method described in this specification aim to include, but are not limited to, these and any other proper storage.

An embodiment of the present application further provides a system. As shown in FIG. 13, a system 50 includes:
the communication apparatus 10 according to the embodiments of the present application and the communication apparatus 20 according to the embodiments of the present application.

An embodiment of the present application further provides a computer storage medium, and the computer storage medium may store a program instruction for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of the present application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in the present application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of the present application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of the present application may be implemented in the form of a software product. The software product is stored in a storage medium, and includes several instructions for instructing a computer device (which may be a personal computer, a server, a network device, or the like) to perform all or some of the steps of the methods described in the embodiments of the present application. The foregoing storage medium includes any medium that can store program code, such as a USB flash drive, a removable hard disk, a read-only memory (Read-Only Memory, ROM), a random access memory (Random Access Memory, RAM), a magnetic disk, an optical disc or the like.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A method, comprising:
sending first information according to one or more learning metrics, wherein the one or more learning metrics are based on at least one of:
distance(s) between distribution(s) of outputs of p latent layer(s) in an artificial intelligence (AI) model and distribution of inputs of the AI model during a training cycle, or
distance(s) between distribution(s) of outputs of p′ latent layer(s) and distribution of outputs of the AI model during the training cycle, and
wherein p and p′ are positive integers.

2. The method according to claim 1, wherein the one or more learning metrics are used to check whether the training cycle is normal.

3. The method according to claim 1,
wherein the one or more learning metrics comprise at least one learning metric corresponding to a first latent layer among the p latent layer(s) or the p′ latent layer(s) during a first time period among n time period(s) in the training cycle, n is a positive integer, and
wherein the at least one learning metric comprises at least one of:
a first learning metric based on a distance between the distribution of the inputs of the AI model and distribution of outputs of the first latent layer during the first time period;
a second learning metric based on a distance between the distribution of the outputs of the AI model and the distribution of the outputs of the first latent layer during the first time period; or
a third learning metric based on a ratio between the first learning metric and the second learning metric.

4. The method according to claim 1, further comprising:
receiving second information, wherein the second information indicates at least one of:
one or more time periods related to S learning metric(s),
one or more latent layers related to the S learning metric(s),
one or more methods for measuring the S learning metric(s), or
one or more types of the S learning metric(s), and
wherein S is a positive integer.

5. The method according to claim 1, wherein the first information indicates the one or more learning metrics.

6. The method according to claim 1, wherein the distance(s) is measured based on at least one of Kullback-Leibler (KL) divergence, Jensen-Shannon divergence (JSD), or Hilbert-Schmidt independence criterion (HSIC).

7. An apparatus, comprising:
at least one processor coupled with a memory storing instructions that, when executed by the at least one processor, cause the apparatus to perform operations, wherein the operations comprise:
sending first information according to one or more learning metrics, wherein the one or more learning metrics are based on at least one of:
distance(s) between distribution(s) of outputs of p latent layer(s) in an artificial intelligence (AI) model and distribution of inputs of the AI model during a training cycle, or
distance(s) between distribution(s) of outputs of p′ latent layer(s) and distribution of outputs of the AI model during the training cycle, and
wherein p and p′ are positive integers.

8. The apparatus according to claim 7, wherein the one or more learning metrics are used to check whether the training cycle is normal.

9. The apparatus according to claim 7,
wherein the one or more learning metrics comprise at least one learning metric corresponding to a first latent layer among the p latent layer(s) or the p′ latent layer(s) during a first time period among n time period(s) in the training cycle, n is a positive integer, and
wherein the at least one learning metric comprises at least one of:
a first learning metric based on a distance between the distribution of the inputs of the AI model and distribution of outputs of the first latent layer during the first time period;
a second learning metric based on a distance between the distribution of the outputs of the AI model and the distribution of the outputs of the first latent layer during the first time period; or
a third learning metric based on a ratio between the first learning metric and the second learning metric.

10. The apparatus according to claim 7, the operations further comprising:
receiving second information, wherein the second information indicates at least one of:
one or more time periods related to S learning metric(s),
one or more latent layers related to the S learning metric(s),
one or more methods for measuring the S learning metric(s), or
one or more types of the S learning metric(s), and
wherein S is a positive integer.

11. The apparatus according to claim 7, wherein the first information indicates the one or more learning metrics.

12. The apparatus according to claim 7, wherein the distance(s) is measured based on at least one of Kullback-Leibler (KL) divergence, Jensen-Shannon divergence (JSD), or Hilbert-Schmidt independence criterion (HSIC).

13. The apparatus according to claim 7, the operations further comprising:
receiving an alarming message indicating that the training cycle is abnormal.

14. An apparatus, comprising:
at least one processor coupled with a memory storing instructions that, when executed by the at least one processor, cause the apparatus to perform operations, wherein the operations comprise:
receiving first information related to one or more learning metrics, wherein the one or more learning metrics are based on at least one of:
distance(s) between distribution(s) of outputs of p latent layer(s) in an artificial intelligence (AI) model and distribution of inputs of the AI model during a training cycle, or
distance(s) between distribution(s) of outputs of p′ latent layer(s) and distribution of outputs of the AI model during the training cycle, and
wherein p and p′ are positive integers.

15. The apparatus according to claim 14, wherein the one or more learning metrics are used to check whether the training cycle is normal.

16. The apparatus according to claim 14, wherein the one or more learning metrics comprise at least one learning metric corresponding to a first latent layer among the p latent layer(s) or the p′ latent layer(s) during a first time period among n time period(s) in the training cycle, n is a positive integer, and
wherein the at least one learning metric comprises at least one of:
a first learning metric based on a distance between the distribution of the inputs of the AI model and distribution of outputs of the first latent layer during the first time period;
a second learning metric based on a distance between the distribution of the outputs of the AI model and the distribution of the outputs of the first latent layer during the first time period; or
a third learning metric based on a ratio between the first learning metric and the second learning metric.

17. The apparatus according to claim 14, the operations further comprising:
sending second information, wherein the second information indicates at least one of:
one or more time periods related to S learning metric(s),
one or more latent layers related to the S learning metric(s),
one or more methods for measuring the S learning metric(s), or
one or more types of the S learning metric(s), and
wherein S is a positive integer.

18. The apparatus according to claim 14, wherein the first information indicates the one or more learning metrics.

19. The apparatus according to claim 14, wherein the distance(s) is measured based on at least one of Kullback-Leibler (KL) divergence, Jensen-Shannon divergence (JSD), or Hilbert-Schmidt independence criterion (HSIC).

20. The apparatus according to claim 14, the operations further comprising:
sending an alarming message indicating that the training cycle is abnormal.
